(19) United States
(12) Patent Application Publication
(10) Pub. No.: US 2020/0404929 A1
(43) Pub. Date: Dec. 31, 2020

(54) FOOD MIXER

(71) Applicant: YUTAKA MFG. CO., LTD., Kounan-shi (JP)

(72) Inventors: Masayasu KURACHI, Kounan-shi (JP); Atsushi TAKAHARA, Kounan-shi (JP); Hideto OMI, Kounan-shi (JP)

(73) Assignee: YUTAKA MFG. CO., LTD., Kounan-shi (JP)

(21) Appl. No.: 16/895,032

(22) Filed: Jun. 8, 2020

(30) Foreign Application Priority Data
Jun. 26, 2019 (JP) 2019-118233

(51) Int. Cl. A21C 1/06; A21C 1/14; B01F 7/04; B02C 13/06; B02C 13/26

(52) U.S. Cl. CPC A21C 1/06; A21C 1/141; B01F 2215/0011; B02C 13/06; B02C 13/26; B01F 7/04

(57) ABSTRACT

A food mixer comprises a container, a rotational shaft, an agitation member, a main packing, a collar, and a sub packing. The rotational shaft penetrates a wall of the container and is rotatably supported by the container. The agitation member is configured to agitate a work product in the container by rotating together with the rotational shaft. The main packing is disposed between the container and the rotational shaft. The collar is held at an outer periphery of the rotational shaft by a fixing member so that a space is formed between the main packing and the collar. The collar allows the space to be opened toward the container when the collar moves away from the fixed position after the fixing state is removed. The sub packing is provided between an outer periphery of the collar and a boss portion.

### CROSS-REFERENCE TO RELATED APPLICATIONS

This application claims priority to Japanese patent application Ser. No. 2019-118233, filed on Jun. 26, 2019, the contents of which are incorporated herein by reference for all purposes.

### STATEMENT REGARDING FEDERALLY SPONSORED RESEARCH OR DEVELOPMENT

Not applicable.

### BACKGROUND

Embodiments of the present disclosure relate to a food mixer used for, for example, crushing, mixing, stirring, and/or kneading foodstuffs.

A food mixer may include a container, a rotational shaft, a stirring member, and packings. Foodstuffs are put into the container. The rotational shaft is rotatably supported by the container. The stirring member is attached to the rotational shaft in order to, for example, crush the foodstuffs. The packings are provided in the proximity of a wall of the container where the rotational shaft penetrates therethrough. When the mixer is working, crushed foodstuffs can stick between the packings and the rotational shaft. The foodstuffs may easily get worse stuck due to heat associated with the rotation of the rotational shaft. Furthermore, when the mixer works under a reduced pressure, the foodstuffs stuck between the packing and the rotational shaft may return to the inside of the container, due to the pressure difference, and can be mixed into fresh foodstuffs. Additionally, the stuck foodstuffs may damage the packing.

To combat this problem, a mixer may have a packing seal having a packing comprised of a first packing and a second packing. The first packing and the second packing form a small enclosed space between them. Additionally, a discharge valve may be provided at the enclosed space.

Foodstuffs stuck in the first packing, which is positioned at a container side, can be washed out to the enclosed space using a washing water and then be discharged from the enclosed space by opening a discharge valve.

### BRIEF SUMMARY

However, it may be difficult to confirm whether the foodstuffs stuck in the first packing has been successfully washed out of the enclosed space with the washing water. Therefore, the mixer needs to be improved.

According to a first aspect of the present disclosure, a food mixer comprises a container, a rotational shaft, an agitation member, a main packing, a collar, and a sub packing. Foodstuff or water may be put in the container. The rotational shaft penetrates a wall of the container and is rotatably supported by the container. The agitation member is fixed to the rotational shaft within the container and is configured to agitate the foodstuff by rotating together with the rotational shaft. The main packing is disposed between the container and the rotational shaft. The main packing may be configured to prevent the foodstuff or the water in the container from leaking out from the container. It may also be configured to prevent outside air or foreign matters from flowing into the container. The collar is held at an outer periphery of the rotational shaft by a fixing member, such that a space is formed between the main packing and the collar in the rotational shaft direction. The collar may have an annular shape. The space is allowed to be opened toward the container by moving the collar away from the fixed position, which may be possible when the fixing state of the collar is removed. The sub packing is provided between an outer periphery of the collar and the container. The sub packing may be configured to prevent the foodstuff or water from leaking out from the container and to prevent outside air and the foreign matters from flowing into the container.

In the first aspect, the rotational shaft may be supported at both ends and traverse in the internal space of the container. Alternatively, the rotational shaft may be supported at one end and extend to the middle of the container. More than one rotational shaft may be provided per a container. Further, the main packing, the sub packing, and the collar may be provided at both ends of the rotational shaft, for instance when the rotational shaft is supported at the both ends. The agitation member may be a plural of rod bodies extending radially from the rotational shaft. The agitation member may be a plurality of rod bodies arranged around the rotational shaft, and extend parallel to the rotational shaft, like a water wheel. The agitation member may be, for example, a screw having the same rotational axis as the rotational shaft. The foodstuff includes, for example, flour being raw material for dough for noodles or bread or a filling for dumplings.

According to the first aspect, when the fixing state of the collar is removed, the collar can be moved from the fixed position. That is, the collar may move from the fixed position, which is an area including the space which had been sealed by the collar. This allows the space to be accessible from the inside of the container. Thus, even if foodstuff is stuck between the sub packing and the rotational shaft, an operator can remove the stuck foodstuff by washing away the stuck foodstuff. Additionally, it is easy to wash the main packing, sub packing, and peripheries around them. In this way, the main packing, sub packing, and their peripheries can be kept clean.

### BRIEF DESCRIPTION OF THE DRAWINGS

FIG. 1 is a perspective view of a simplified version of a whole of a mixer, according to a first embodiment of the present disclosure.

FIG. 2 is an enlarged cross-sectional view of a portion of a wall of the container where the rotational shaft penetrates, according to the first embodiment.

FIG. 3 is an enlarged front view of a rotating body (e.g., a blade), according to the first embodiment.

FIG. 4 is an enlarged front view of a rotating body (e.g., a blade) according to a second embodiment of the present disclosure.

FIG. 5 is an enlarged cross-sectional view illustrating a sub packing according to a third embodiment of the present disclosure.

### DETAILED DESCRIPTION

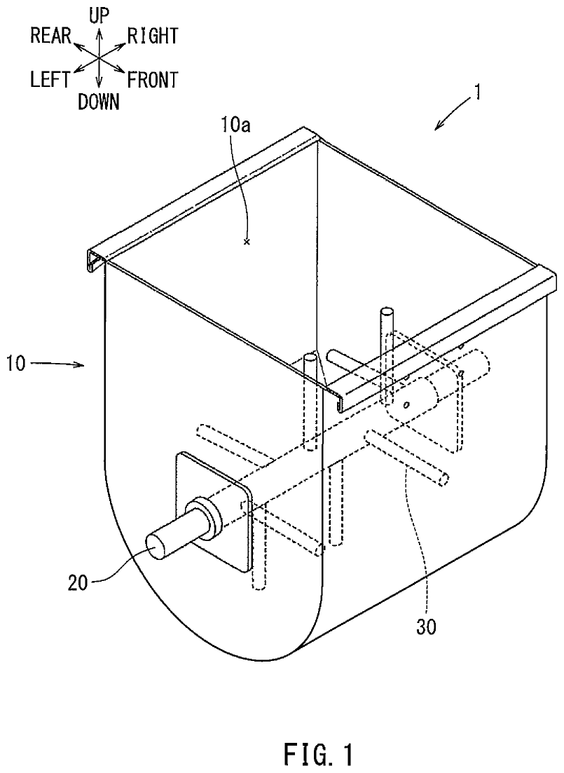

FIG. 1 illustrates a food mixer according to a first embodiment. The food mixer 1 has a container 10, a rotational shaft 20, and agitation members 30. The container 10 has an opening on its upper side, through which items to be mixed, such as foodstuff and/or water, may be placed. The rotational shaft 20 may be extended through the container 10 in the horizontal direction near the bottom of the container 10 and be rotatably supported by the container 10. The agitation members 30 may be fixed to an outer periphery of the rotational shaft 20. The agitation members 30 can be configured to agitate foodstuff put in the container 10 by rotating together with the rotational shaft 30. The foodstuff may include, for example, flour as a raw material for dough for noodles or bread, dumpling filling, water as needed, etc. The foodstuff is put into the container, together with water, and then agitated by the agitation members 30. The container 10 may be rotatably supported in the forward and backward directions by a support member (not shown). The agitated, mixed, or kneaded foodstuff in the container 10 can be removed from the upper opening 10a of the container 10 by inclining the container 10. Arrows in FIG. 1 illustrate each reference direction, in a state in which the container 10 is supported by the support member. The reference directions indicated by the arrows are the same in the detailed description and FIGS. 1 to 5.

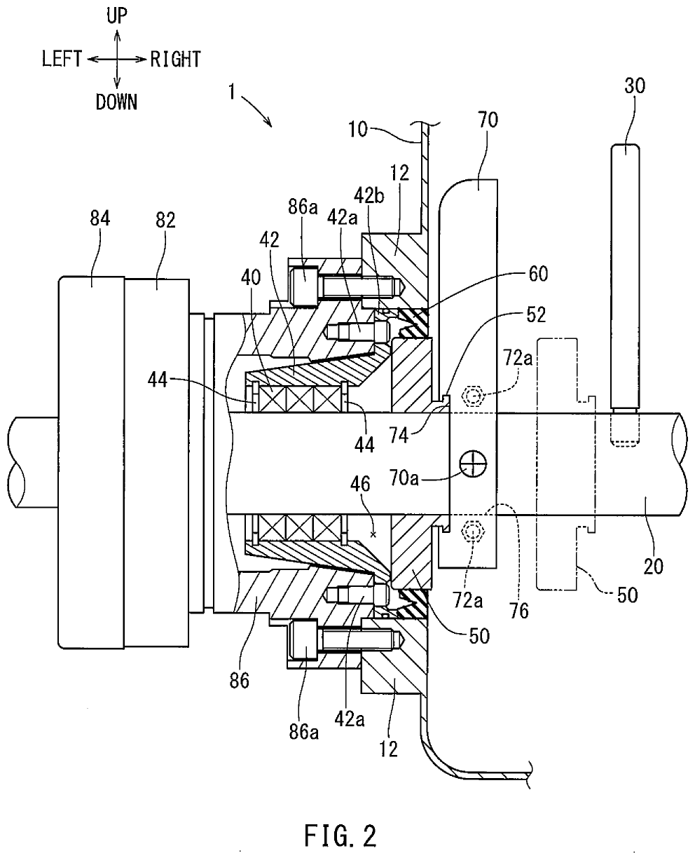

As illustrated in FIG. 2, the rotational shaft 20 penetrates a side wall of the container 10 and is supported by bearings 84. The bearings 84 are fixed to a cover 86 via a support member 82. The cover 86 is fixed to a boss portion 12 of the container 10 by bolts 86a. The cover 86 may have a container shape projecting in the left direction. A main packing 40 is provided in the container shaped space in the cover 86. The main packing 40 is held at an inner periphery side of a packing holder 42, which may have a cylindrical shape. The packing holder 42 has an outer periphery end portion 42b fixed to an opening side end portion of the cover 86 by bolts 42a. The main packing 40 may have an annular shape and a size to fit around the perimeter of the rotational shaft 20. The main packing 40 may be sandwiched between the inner periphery surface of the packing holder 42 and the outer periphery surface of the rotational shaft 20. The main packing 40 can prevent the foodstuff from leaking out of the container 10 and prevent outside air or foreign materials from flowing into the container 10. The main packing 40 is fixed to the packing holder 42 by fixing rings 44, so that the main packing 40 does not move in the horizontal direction. The fixing rings 44 are provided at both edge portions of the main packing 40 in the shaft (e.g., horizontal) direction.

As shown in FIG. 2, there is a space 46 formed next to the main packing 40 in the rotational shaft 20 direction, toward the container 10. The space 46 is positioned between the main packing 40 and an annular collar 50. The collar 50 is provided at the outer periphery of the rotational shaft 20. The collar 50 has an outer diameter similar to that of the packing holder 42. The outer peripheral surface of the collar 50 faces an inner peripheral surface of the boss portion 12. A sub packing 60 is inserted between the outer peripheral surface of the collar 50 and the inner peripheral surface of the boss portion 12. Thus, the container 10 is sealed by both the main packing 40 and the sub packing 60. The space 46 is formed between the main packing 40 and the sub packing 60.

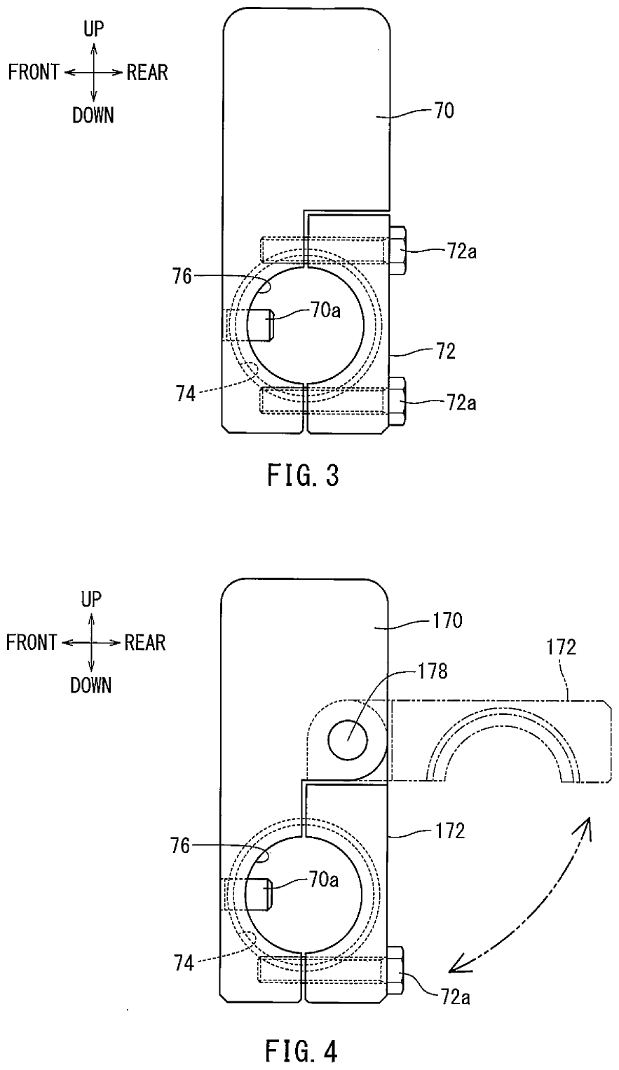

A blade 70 may be disposed within the inside of the container 10, for instance on the right side relative to the collar 50, in the rotational shaft 20 direction. The blade 70 may be comprised of a piece of plate and may correspond to a rotating body and a fixing member in the present disclosure. The collar 50 and the blade 70 may be connected by one or more fitting projection portion 52 extending from the collar 50 into one or more recess portion 74 of the blade 70. The blade 70 has a through hole 76. The rotational shaft 20 is inserted into the through hole 76. As illustrated in FIG. 3, a locking screw 70a is provided within the through hole 76 so that the locking screw 70a can be screwed toward the inside of the through hole 76. In this way, the blade 70 may be secured to the rotational shaft 20 by screwing the locking screw 70a, with the rotational shaft 20 already being inserted in the through hole 76. Also, the collar 50 may be secured to the rotational shaft 20 via the blade 70 at this time. In this way, the collar 50 may be secured to the rotational shaft 20 in an indirect manner, by securing the blade 70 to the rotational shaft 20. Alternatively, the collar 50 may be secured directly to the rotational shaft 20, for instance by a dedicated fixing member or other suitable method. In this embodiment, the blade 70, which rotates adjacent to an inner surface of the container 10, is needed to prevent the foodstuff agitated in the container 10 from adhering to the inner surface. Additionally, the blade 70 is used to secure the collar 50 to the rotational shaft 20. Thus, a dedicated fixing member is not necessarily used to removably secure the collar 50 to the rotational shaft 20 in this embodiment.

As illustrated in FIG. 3, the blade 70 may be configured so that the through hole 76 may be opened. For instance, the blade 70 may have a split body 72 forming a part of the through hole 76. The split body 72 is separably attached to the blade 70 by a pair of bolts 72a. Thus, the blade 70 may be removed from the rotational shaft 20 by removing the split body 72 from the rest of the blade 70. When the blade 70 is removed from the rotational shaft 20, the collar 50 also can be removed from the position at which it was previously secured along the rotational shaft 20. The projection portions 52 of the collar 50 and the recess portions 74 of the blade 70 are formed around the through hole. Thus, the connection between the collar 50 and the blade 70 may be easily released by removing the split body 72 from the blade 70.

A virtual line in FIG. 2 shows the collar 50 being moved toward the inside of the container 10 (to the right direction in this Figure) along the rotational shaft 20. When the collar 50 is positioned in the inside of the container 10, the space 46 may now communicated with an internal space of the container 10. Thus, when washing the internal space of the container 10, for example after the completion of mixing the foodstuff, the space 46 can be washed together with the container 10. Even if a portion of the mixed foodstuff had previously leaked into the space 46 through the sub packing 60, the leaked foodstuff can be removed while washing the internal space of container 10.

An outer periphery of the collar 50 has substantially the same diameter as that of the packing holder 42. Thus, when the collar 50 is moved in the right direction, as shown by the virtual line in FIG. 2, the space 46 opens wide toward the inside of the container 10. Accordingly, washing the space 46 becomes easier. The sub packing 60 is disposed at the outer periphery of the collar 50, rather than around the outer periphery of the rotational shaft 20. Thus, the sub packing 60 can be protected from being damaged by a worked surface formed at the outer periphery of the rotational shaft 20. The sub packing 60 has an annular shape which is cut at one portion. Thus, the sub packing 60 is removable from the rotational shaft 20 when the collar 50 is located at the virtual line position in FIG. 2. Thus, the outer periphery of the sub packing 60 and the space 46 can be washed much easier.

It is noted that the same structure as described above may also be provided at the opposite side of the rotational shaft 20, penetrating the opposite side wall of the container 10.

FIG. 4 illustrates a second embodiment of the present disclosure. In the second embodiment, a blade 170 has a split body 172 forming a part of the through hole 76. The difference between the first embodiment and the second embodiment is that the split body 172 is hinge-connected to the blade 170. The other structures may be substantially the same as the first embodiment and thus, the same description for the same structures are omitted.

The split body 172 is formed as a part of the blade 170, similar to the split body 72 of the first embodiment. The split body 172 is configured to open the through hole 76. The split body 172 is connected to the blade 170 by a hinge member 178, so that the split body 172 freely rotates relative to the blade 170. The split body 172 may be further attached to the blade 170 by a bolt 72a, to fully enclose the through hole 76. The blade 170 can be removed from the rotational shaft 20 by rotating the split body 172 around the hinge member 178, in an arrow direction as illustrated by a virtual line in FIG. 4. As a result of the blade 170 being removed, the collar 50 can be moved to the virtual line position in FIG. 2, to allow for washing the space 46.

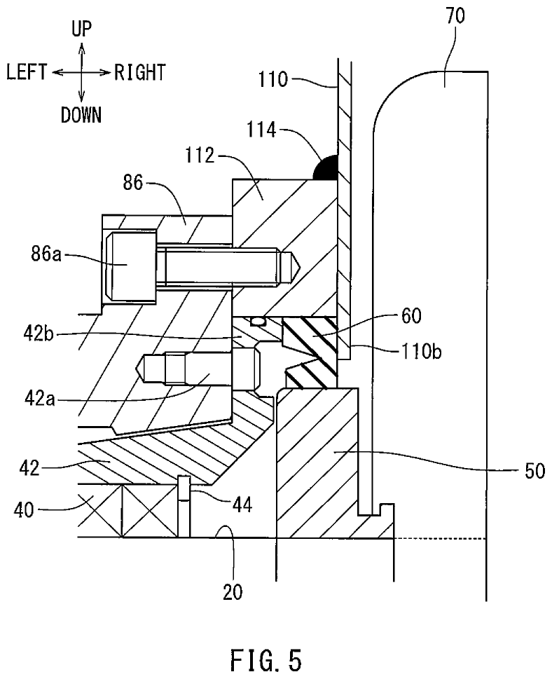

FIG. 5 illustrates a third embodiment of the present disclosure. One of the differences between the first embodiment and the third embodiment is that a container 110 is configured to prevent the sub packing 60, which is inserted between the outer periphery of the collar 50 and the inner periphery of a boss portion 112, from moving toward the inside of the container 110 (in the right direction in this Figure). The other structures of the third embodiment may be substantially the same as the first embodiment. Thus the description for the same structures are omitted.

In the third embodiment, the boss portion 112 may be attached to a main body of the container 110, for instance by a welding connection. The container 110 has an end portion 110b extending toward the rotational shaft 20. The end portion 110b may be configured to extend beyond a right side surface of the boss portion 112. A weld bead 114, which is formed by the welding, may be formed at a boundary between the boss portion 112 and the main body of the container 110.

The end portion 110b is located adjacent to the right side of the sub packing 60. The sub packing 60 may be supported in the horizontal direction by the outer periphery end portion 42b of the packing holder 42 and the end portion 110b of the container 110. Thus, the sub packing 60 can be held so as not to move in the horizontal direction, thereby maintaining its sealing function. In this way, the outer periphery end portion 42b and the end portion 110b can serve as a positioning member for the sub packing 60, by supporting the left side and the right side of the sub packing 60 in the third embodiment. In contrast, in the first embodiment, the sub packing 60 may be supported only from the left side by the outer periphery end portion 42b.

While the present disclosure has been described herein with reference to specific embodiments, various kinds of changes, additions, or deletion may be possible, for example, but not limited to, related to their appearances or structures. For example, the blade 70 is adopted as the rotating body in the above embodiments. However, a round stick-like agitation member 30 may be used as the rotating body. The collar 50 is movable along the shaft 20 in the above embodiments, when not being held by the blade 70. However, the collar 50 may be configured to be removable from the rotational shaft 20. Although only one sub packing 60 is used in the above embodiment, more than one sub packing 60 may be used in any combination thereof. In the above embodiment, the sub packing 60 has an annular shape cut at one portion. However, the sub packing 60 may not necessarily be cut.

What is claimed is:

1. A food mixer, comprising:
a container in which to put foodstuff or water,
a rotational shaft penetrating a wall of the container so that the rotational shaft is supported rotatably in the container,
an agitation member fixed to the rotational shaft in the container to agitate the foodstuff by rotating together with the rotational shaft,
a main packing disposed between the container and the rotational shaft to prevent the foodstuff or the water in the container from leaking out from the container and prevent outside air or foreign matters from flowing into the container,
a collar held at an outer periphery of the rotational shaft by a fixing member so that a space is formed in the rotational shaft direction between the main packing and the collar, and the collar having an annular shape and being configured to be moved away from a fixed position to allow the space to be opened toward the container after the fixing state of the collar is removed,
a sub packing disposed between an outer periphery of the collar and the container to prevent the foodstuff or the water from leaking out from the container and prevent the outside air and the foreign matters from flowing into the container.

2. The food mixer according to claim 1, wherein the sub packing has an annular shape surrounding the outer periphery of the collar and is configured to be separable by opening the annular shape.

3. The food mixer according to claim 1, wherein the fixing member is a rotating body fixed to the rotational shaft and located on the inner side of the container relative to the collar to prevent the foodstuff in the rotating container from adhering to an inner wall of the container by rotating together with the rotational shaft, wherein the fixing member is removably connected with the collar.

4. The food mixer according to claim 1, further comprising a positioning member fixed to the container to prevent the sub packing from moving while a portion of the positioning member contacts with a side portion of the sub packing.

5. The food mixer according to claim 1, wherein the collar has an outer diameter larger than an outer diameter of the main packing.

6. A food mixer, comprising:
a container;
a rotational shaft penetrating a wall of the container and rotatably supported by the container;
a main packing disposed between the container and the rotational shaft to seal therebetween;
a collar removably fixed to an outer periphery of the rotational shaft by a fixing member so that a space is formed between the main packing and the collar in a rotational shaft direction, the collar being configured to be moved away from a fixed position to allow the space to be opened toward the container; and
a sub packing disposed between an outer periphery of the collar and the container to seal therebetween.

7. The food mixer according to claim 6, wherein the sub packing is removable in a direction toward an inner side of the container.

8. The food mixer according to claim 6, wherein the fixing member is a rotating body fixed to the rotational shaft and is located on an inner side of the container relative to the collar to prevent a work product from adhering to an inner wall of the container, wherein the fixing member is removably connected to the collar.

9. The food mixer according to claim 8, wherein the rotating body contacts an outer surface of the collar.

10. The food mixer according to claim 8, wherein the collar further comprises a fitting projection radially extending into the rotating body.

11. The food mixer according to claim 6, further comprising a positioning member fixed to the container to prevent the sub packing from moving by contacting a side portion of the sub packing.

12. A mixer, comprising:
a container having an internal space;
a rotational shaft positioned within the internal space of the container and penetrating through an opening formed in a wall of the container;
a main packing sealably contacting an outer peripheral surface of the rotational shaft at a position outside the internal space of the container;
a collar removably fixed to the outer peripheral surface of the rotational shaft at a position spaced apart from the main packing and nearer the internal space of the container than the main packing; and
a sub packing sealably contacting an outer peripheral surface of the collar and positioned between the collar and the wall of the container.

13. The mixer according to claim 12, wherein the collar has an outer diameter larger than an outer diameter of the main packing.

14. The mixer according to claim 12, wherein the sub packing has an outer diameter larger than an outer diameter of the main packing.

15. The mixer according to claim 12, wherein a diameter of the opening formed in the wall of the container is smaller than an outer diameter of the sub packing.

16. The mixer according to claim 12, wherein the collar is directly fixed to the rotational shaft.

17. The mixer according to claim 12, wherein the collar is indirectly fixed to the rotational shaft by a rotating body removably fixed to the rotational shaft.

18. The mixer according to claim 17, wherein the rotating body is positioned nearer the wall of the container than an agitation member fixed to and extending from the rotational shaft at a position within the internal space of the container.

19. The mixer according to claim 12, wherein:
the collar has a through hole through which the rotational shaft passes, and
the collar is configured to slide along the rotational shaft after a fixing state of the collar with the rotational shaft has been removed.

20. The mixer according to claim 19, wherein the fixing state of the collar with the rotational shaft is removed by splitting apart a rotating body configured to fix the collar to the rotational shaft.
